(19) United States
(12) Patent Application Publication
(10) Pub. No.: US 2025/0271284 A1
(43) Pub. Date: Aug. 28, 2025

(54) SELF-CALIBRATING ANGLE SENSOR

(71) Applicant: TEXAS INSTRUMENTS INCORPORATED, Dallas, TX (US)

(72) Inventor: TERRY MAYHUGH, RICHARDSON, TX (US)

(21) Appl. No.: 18/588,231

(22) Filed: Feb. 27, 2024

(51) Int. Cl. G01D 5/244; G01D 18/00

(52) U.S. Cl. CPC G01D 5/24428; G01D 18/001; G01D 2205/26; G01D 2218/00

(57) ABSTRACT

An integrated circuit (IC) includes first, second, and third magnetic sensors. An analog-to-digital converter (ADC) has an input coupled to the first, second, and third magnetic sensors, and has an output. A digital circuit has an input coupled to the output of the ADC. The digital circuit is configured to obtain first digital sensor values from the ADC, determine interim rotation matrices for rotation of the first digital sensor values, and determine a calibration matrix based on the interim rotation matrices.

### BACKGROUND

Magnetic sensors can be used to calculate the angle of a rotation shaft, e.g., a rotating shaft of a motor. A magnet positioned on the rotating shaft rotates with the shaft, and the magnetic sensors sense the rotating magnetic field of the magnet. The angle of the magnet relative to the magnetic sensors can be calculated and used as a feedback signal to a motor controller to control the angle of the motor's shaft. Misalignment between the magnetic sensors and the magnet may cause errors in the angle calculated from the sensed magnetic field.

### SUMMARY

In one example, an integrated circuit (IC) includes first, second, and third magnetic sensors. An analog-to-digital converter (ADC) has an input coud to the first, second, and third magnetic sensors, and has an output. A digital circuit has an input coupled to the output of the ADC. The digital circuit is configured to obtain first digital sensor values from the ADC, determine interim rotation matrices for rotation of the first digital sensor values, and determine a calibration matrix based on the interim rotation matrices.

In another example, an IC includes magnetic sensors and an ADC having an input coupled to the magnetic sensors. The ADC has an output. A digital circuit has an input coupled to the output of the ADC. The digital circuit is configured to apply a rotation correction to digital sensor values from the ADC to thereby determine rotation-corrected sensor values and then determine an angle based on the rotation-corrected sensor values.

In yet another example, a method includes obtaining values from magnetic sensors and determining interim rotation matrices for rotation of the sensor values. The method also includes determining a calibration matrix based on the interim rotation matrices.

In another example, a method includes applying a rotation correction to values from magnetic sensors to determine rotation-corrected sensor values. The method further includes determining an angle based on the rotation-corrected sensor values.

Another example is directed to a method that includes obtaining first values from magnetic sensors and determining interim rotation matrices for rotation of the first values. The method further includes determining a calibration matrix based on the interim rotation matrices, applying the calibration matrix to second values from the magnetic sensors to determine rotation-corrected sensor values, and determining an angle based on the rotation-corrected sensor values.

### BRIEF DESCRIPTION OF THE DRAWINGS

FIG. 1 is a system diagram including a motor, a magnet, and a self-calibrating angle sensor device, in an example.

FIGS. 2A-2D are diagrams illustrating different types of misalignment errors between the magnet and self-calibrating angle sensor device.

FIG. 3 is a graph of a sensor constellation with misalignment errors.

FIG. 4 is a block diagram of the self-calibrating angle sensor device of FIG. 1, in an example.

FIG. 5 is a block diagram of a digital circuit usable to perform a calibration for the self-calibrating angle sensor device, in an example.

FIG. 6 is a block diagram of operations performed by the self-calibrating angle sensor device including a rotation correction, in an example.

FIG. 7 is a block diagram of the rotation correction of FIG. 6, in an example.

FIG. 8 is a block diagram of a linear transformation included in the rotation correction, in an example.

FIG. 9 is a block diagram of a quadratic transformation included in the rotation correction, in an example.

FIG. 10 is a flow diagram of how a calibration matrix is determined, in an example.

FIG. 11 is a flow diagram of to determine a three-dimensional rotation matrix, in an example.

FIG. 12 is a flow diagram of how to modify sensor values using the rotation matrix, in an example.

### DETAILED DESCRIPTION

The same reference numbers or other reference designators are used in the drawings to designate the same or similar (either by function and/or structure) features.

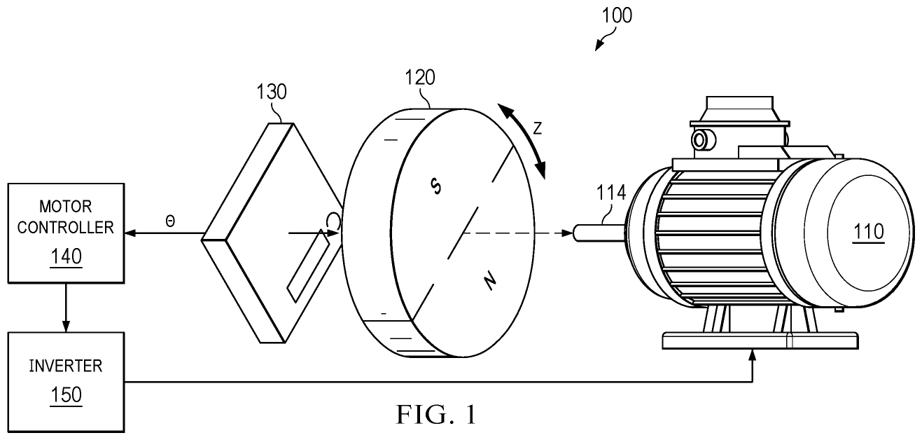

FIG. 1 is a system diagram including a motor 110, a magnet 120, a self-calibrating angle sensor device 130, a motor controller 140, and an inverter 150. In some examples, motor 110 may be a three-phase motor, and, under control by motor controller 140, inverter 150 provides current to each phase of motor 110. Motor 110 includes a rotating shaft 114 to which magnet 120 is attached. The diameter of magnet 120 may be exaggerated relative to the diameter of rotating shaft 114 for ease of view. In some examples the diameter of magnet 120 may match the diameter of rotating shaft 114. Magnet 120 rotates as shaft 114 rotates. The rotating magnet also causes its magnetic field to rotate. Self-calibrating angle sensor device 130 includes multiple orthogonally-arranged magnetic sensors, e.g., Hall-effect sensors, to detect the rotating magnetic field. Self-calibrating angle sensor device 130 calculates the angle (Θ) of the magnetic field relative to the self-calibrating angle sensor device. Self-calibrating angle sensor device 130 may calculate the angle multiple times per revolution of shaft 114. Motor control 140 obtains the angle Θ from self-calibrating angle sensor device 130 and uses the angle to determine when to commutate motor 110. Inverter 150 may include a separate phase for each of the phases of motor 110, and motor controller 140 changes the commutation of motor 110 by controlling the state of each of the inverter's phases.

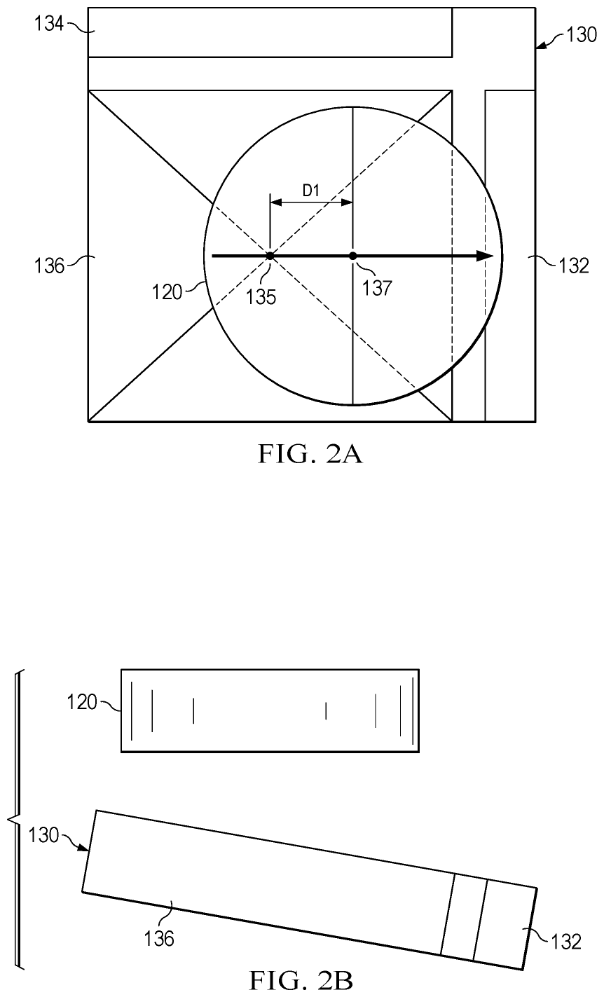

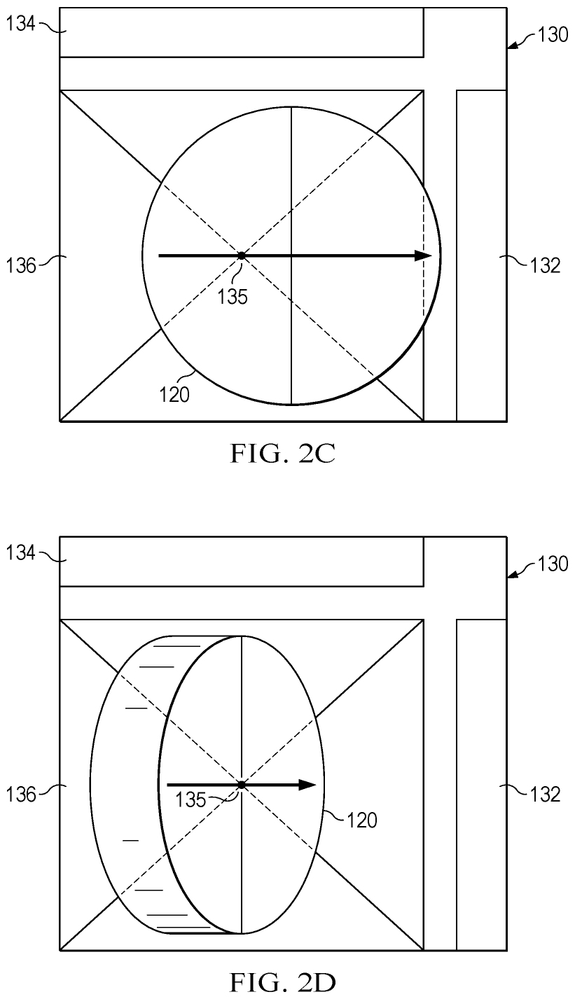

Self-calibrating angle sensor device 130 may be positioned close to magnet 120 and centered with respect to magnet 120. FIGS. 2A-2D are diagrams illustrating different types of misalignment errors that can occur between self-calibrating angle sensor device 130 and magnet 120. Absent the self-calibrating benefit of self-calibrating angle sensor device 130, misalignment errors can reduce the accuracy of the calculated angle Θ, and accordingly, detrimentally impact the ability of motor controller 140 to accurately control motor 110. Self-calibrating angle sensor device 130 includes three orthogonally-arranged magnetic sensors. The three orthogonal magnetic sensors are arranged along X, Y, and Z axes within self-calibrating angle sensor device 130. As described below, self-calibrating angle sensor device 130 uses the three magnetic sensors to calibrate itself to calculate angle Θ.

FIG. 2A is an example of an offset error. Self-calibrating angle sensor device 130 includes a center alignment point 135 to which the magnet 120 should be centered. In FIG. 2A, magnet 120 has a center point 137 about which the magnet rotates. In the offset error example of FIG. 2A, the magnet's center point 137 is not aligned to center alignment point 135 of self-calibrating angle sensor device 130. The offset D1 between the two points 135 and 137 causes an error in the calculation of angle Θ. FIG. 2B is an example of sensor tilt in which magnet 120 is not positioned parallel to self-calibrating angle sensor device 130. FIG. 2C is an example of a run-out error in which the center of the rotating shaft 114 is centered on center alignment point 135 of self-calibrating angle sensor device 130 but the magnet itself is not centered on the rotating shaft 114. As a result of the misalignment between magnet 120 and shaft 114, magnet 120 rotates in an elliptical path about center alignment point 135. FIG. 2D is an example of magnetic tilt in which magnet 120 is positioned at an angle with respect to rotating shaft 114. Without the self-calibrating feature of self-calibrating angle sensor device 130, any of the offset, sensor tilt, run-out, and magnetic tilt errors illustrated in FIGS. 2A-2D can cause a miscalculation of angle Θ. In some systems, multiple of the offset, sensor tilt, run-out, and magnetic tilt errors may be present.

The alignment errors may result from manufacturing tolerances that are intentionally included in the assembly process to mount magnet 120 on shaft 114 and self-calibrating angle sensor device 130 with respect to magnet 120. In some cases, pick-and-place equipment is used to place self-calibrating angle sensor device 130 on a printed circuit board (PCB). The accuracy of the positioning of self-calibrating angle sensor device 130 by the pick-and-place equipment is a function of the tolerances inherent in the equipment. Further, assembly of the die containing the magnetic sensors within the integrated circuit (IC) package can result in rotation, tilt, and/or offset errors.

Values obtained from the sensors 132, 134, and 136 at the same time are referred to herein as a coordinate. As shaft 114 turns, the self-calibrating angle sensor device 130 obtains multiple coordinates from its sensors. Multiple coordinates from the sensors 132, 134, and 136 are referred to as a constellation of coordinate (or constellation for simplicity).

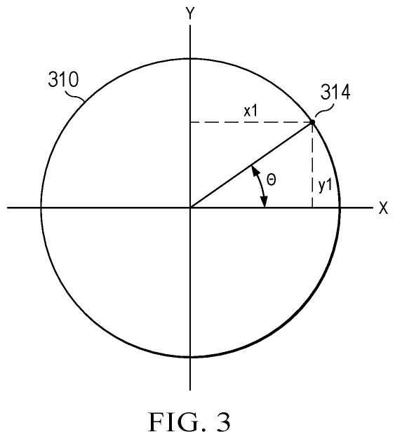

Absent the misalignment errors of FIGS. 2A-2D, the magnetic field that rotates due to the rotating magnet will only have an amplitude in along two axes, for example, the axis of the X-axis sensor 132 and the axis of the Y-axis sensor 134, and the Z-axis sensor 136 will not detect any magnetic field. Further, absent the misalignment errors, the constellation of X, Y coordinates will be a circle in the X, Y plane. FIG. 3 is a graph of a circle 310 on the X, Y plane. Each point on circle 310 represents a coordinate including a value from the X-axis sensor 132 and a value from the Y-axis sensor 134 obtained concurrently. An example point of such a coordinate is coordinate 314, which includes X and Y sensor values X1 and Y1. The angle of shaft 114 relative to the X-axis and Y-axis sensors 132 and 134 is shown as angle Θ in FIG. 3. Self-calibrating angle sensor device 130 may calculate angle Θ as:

$$θ = {tan}^{- 1} ( \frac{Y 1}{X 1} ) \qquad ( Eq . 1 )$$

However, due to one or more misalignment errors, the rotating magnetic field will have a magnitude in all three axes. Further, the shape of the constellation of coordinates may be an ellipse, not a circle as in FIG. 3.

Self-calibrating angle sensor device 130 advantageously can calibrate itself given any of the possible offset, sensor tilt, run-out, and magnetic tilt alignment error that may be present. Without the ability for self-calibration, the system integrator of system 100 would be forced to perform a manual calibration of an angle sensor device using specialized equipment to accurately measure angle Θ and create a look-up table mapping accurate measurements of angle Θ to the angle calculated by the angle sensor device. The resulting look-up table would then be loaded into memory in the angle sensor device. The more data that is included in the look-up table, the more accurate would be the angle sensor device's ability to calculate angle Θ. Unfortunately, in addition to burdening the system integrator with this manual calibration process, large look-up tables require large amounts of memory in the angle sensor device thereby making the device large and expensive. Advantageously, the self-calibration capability of self-calibrating angle sensor device 130, described herein, avoids the need for manual calibration and a large look-up table.

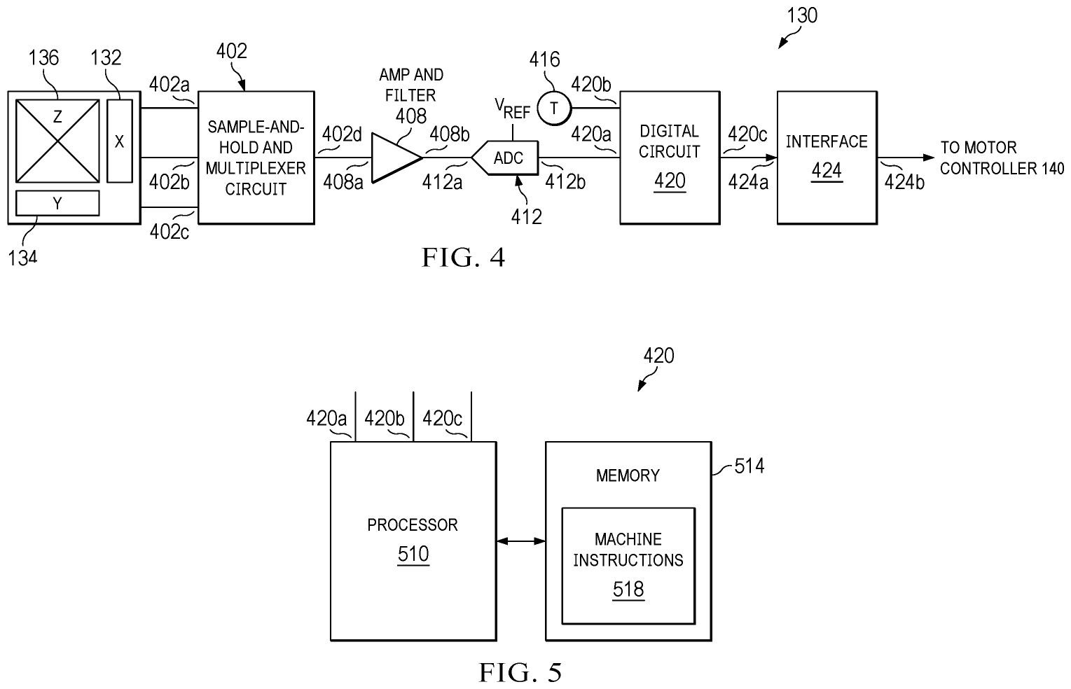

FIG. 4 is a block diagram of self-calibrating angle sensor device 130, in an example. Self-calibrating angle sensor device 130 includes X-axis sensor 132, Y-axis sensor 134, Z-axis sensor 136, a sample-and-hold and multiplexer circuit 402, an amplifier and filter 408, an analog-to-digital converter (ADC) 412, a temperature sensor 416, a digital circuit 420, and an interface 424. Sample-and-hold and multiplexer circuit 402 has inputs 402a, 402b, and 402c coupled to respective X-axis sensor 132, Y-axis sensor 134, and Z-axis sensor 136. Sample-and-hold and multiplexer circuit 402 has an output 402d coupled to an input 408a of amplifier and filter 408. Amplifier and filter 408 has an output 408b coupled to an input 412a of ADC 412. ADC 412 has an output 412b coupled to an input 420a of digital circuit 420. Temperature sensor 416 is coupled to an input 420b of digital circuit 420. Digital circuit 420 has a terminal 420c coupled to a terminal 424a interface 424. Interface 424 has a terminal 424b to which motor controller 140 can be coupled.

Sample-and-hold and multiplexer circuit 402 may sample and hold any or all of the output signals from the X-axis sensor 132, Y-axis sensor 134, and Z-axis sensor 136. In one example, sample-and hold and multiplexer circuit 402 may sample and hold the output signals from any pair or all of the X-axis sensor 132, Y-axis sensor 134, and Z-axis sensor 136 approximately simultaneously. Sample-and-hold and multiplexer circuit 402 holds, e.g., charges a capacitor, the signal level of the sensors 132, 134, 136. Each such held signal can then be sequentially processed through amplifier and filter 408, ADC 412, and digital circuit 420. For example, the signal chain formed by amplifier and filter 408, ADC 412, and digital circuit 420 may process the held signal of one of the X-axis sensor 132, Y-axis sensor 134, or Z-axis sensor 136, then the next held signal, and so forth. Amplifier and filter 408 amplifies and filters, e.g., low-pass filters, the signal. ADC 412 converts the amplified and filtered analog signal to a digital value for subsequent processing by digital circuit 420. The example of FIG. 4 includes a single signal chain to sequentially process the sensor signals. Other examples include a separate a separate signal chain to process the three sensor signals concurrently.

Interface 424 provides an interface to which motor controller 140 can be coupled. Interface 424 may be any suitable type of interface such as a Single Edge Nibble Transmission (SENT) interface. Digital circuit 420 may calculate angle Θ, and motor controller 140 may retrieve the calculated angle Θ from self-calibrating angle sensor device 130 by way of interface 424.

The components shown in the example of FIG. 4 may all be fabricated as part of the same semiconductor package. The components may all be fabricated on the same semiconductor die within the package. Alternatively, two or more of the components may be fabricated on separate dies, and the dies then packaged together as one device.

FIG. 5 is an example block diagram of digital circuit 420. In this example, digital circuit 420 includes a processor 510 coupled to a memory device 514. Memory device 514 is a non-transitory storage device such as random-access memory, read-only memory, etc. Machine instructions 518 are stored in memory device 514. Processor 510 retrieves the machine instructions 518 from memory device 514 and executes the instructions. The functionality described herein as attributable to the digital circuit 420 can be performed by processor 510 through its execution of machine instructions 518.

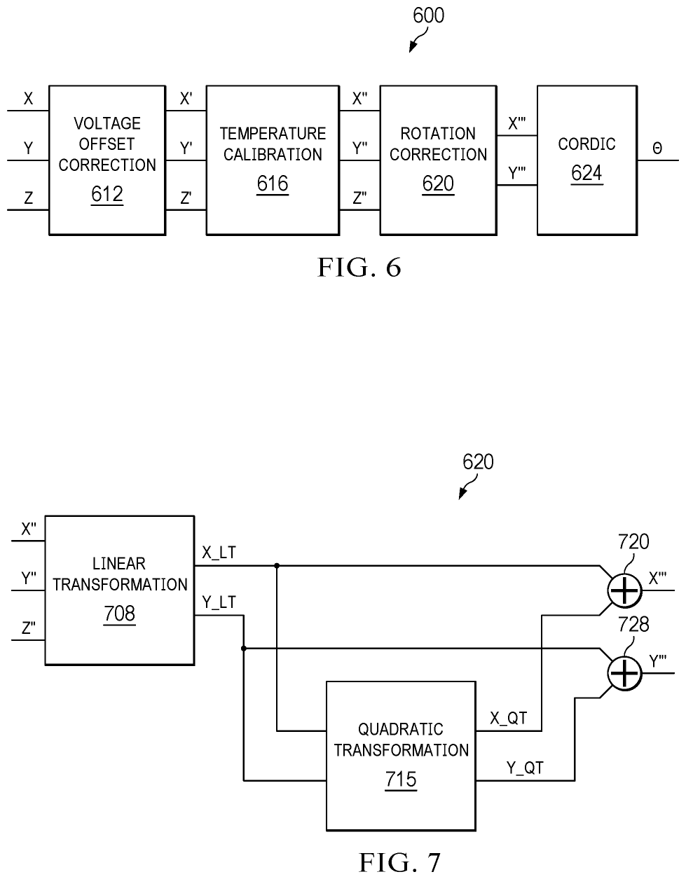

FIG. 6 is a flow diagram 600 illustrating a voltage offset correction 612, a temperature calibration 616, and a rotation correction 620 performed by digital circuit 420 on each coordinate of values from the X-axis sensor 132, the Y-axis sensor 134, and the Z-axis sensor 136, for simplicity shown in FIG. 5 as the coordinate X, Y, and Z. In one example, the voltage offset correction 612, temperature calibration 616, and rotation correction 620 are performed by processor 510 executing machine instructions 518. Each of the magnetic sensors may have a direct current (DC) voltage offset which detrimentally impacts the angle measurement. Voltage offset correction 612 receives the coordinate X, Y, and Z from the sensors (after being amplified, filtered, and digitized as described above) and determines the DC voltage offset for each sensor and subtracts the DC offset from the sensors' signals. The voltage offset-corrected output of offset correction 612 is the coordinate X′, Y′, and Z′. Temperature calibration 616 uses a reading from temperature sensor 416 to correct the X′, Y′, and Z′ coordinate for changes in ambient temperature of self-calibrating angle sensor device 130 to produce the coordinate X″, Y″, and Z″.

Rotation correction 620 corrects the X″, Y″, and Z″ values due to any of the misalignment errors explained above. Rotation correction 620 rotates the constellation of coordinates from the X, Y, Z space to the X, Y plane, with little or no Z component, and also scales the resulting constellation in the X, Y plane to convert it from an ellipse to a circle. Rotation correction 620 applies a rotation correction to the coordinate X″, Y″, and Z″. In one example, the rotation correction includes a calibration matrix that is applied to the X″, Y″, and Z″ coordinate. The X″, Y″, and Z″ coordinate may be multiplied by the calibration matrix. The output of the rotation correction function 620 is X″′ and Y″′. FIGS. 1-13G and the corresponding text below describe an example for how the calibration matrix can be determined.

In this example, it is assumed that self-calibrating angle sensor device 130 is oriented relative to magnetic 120 such that the X-axis sensor 132 and the Y-axis sensor 134 are orthogonal to the rotating magnetic field and should be the primary sensors to detect the magnetic field, not the Z-axis sensor 136. However, the calibration process described herein applies to whichever of the two orthogonal sensors are primarily orthogonal to the rotating magnetic field and rotates the constellation to the plane defined by those sensors.

The output X″′, Y″′ coordinate from the rotation correction 620 is provided to coordinate rotation digital computer (CORDIC) 624 calculates angle Θ based on X″′ and Y″′. In one example, CORDIC 624 may calculate angle Θ using Eq. (1) above. CORDIC 624 may be performed by processor 510 executing machine instructions 518.

FIG. 7 is a block diagram of rotation correction 620. Rotation correction 620 includes a linear transformation 708, a quadratic transformation 715, and adders 720 and 728. The linear transformation converts the constellation of sensor coordinates from the X, Y,Z space to the X,Y plane with little or no Z component remaining and scales the resulting constellation to make it a circle. As described above, two or more of the misalignment errors of FIGS. 2A-2D may be present at the same time in any given system. If such multi-alignment errors are present, the resulting constellation resulting from the linear transformation 708 may still have a Z component. The quadratic formation 715 may be included to further reduce the Z component to further improve the accuracy of the calculated angle Θ.

The inputs to the linear transformation 708 are the X″, Y″, and Z″ coordinates from the temperature calibration 616. The outputs of the linear transformation 708 are X_LT and Y_LT. The X_LT and Y_LT output coordinate from the linear transformation 708 is provided as input into the quadratic transformation 715, the output of which is X_QT and Y_QT. Adder 720 adds X_LT and X_Q to produce X″′. Similarly, adder 728 adds Y_LT and Y_QT to produce Y′″ In an example in which the quadratic transformation 715 is not included or not performed, the output coordinate X_LT, Y_LT from the linear transformation 708 is the X″′, Y″′ output of the rotation correction 620—adders 720 and 728 are not included or not used in this example.

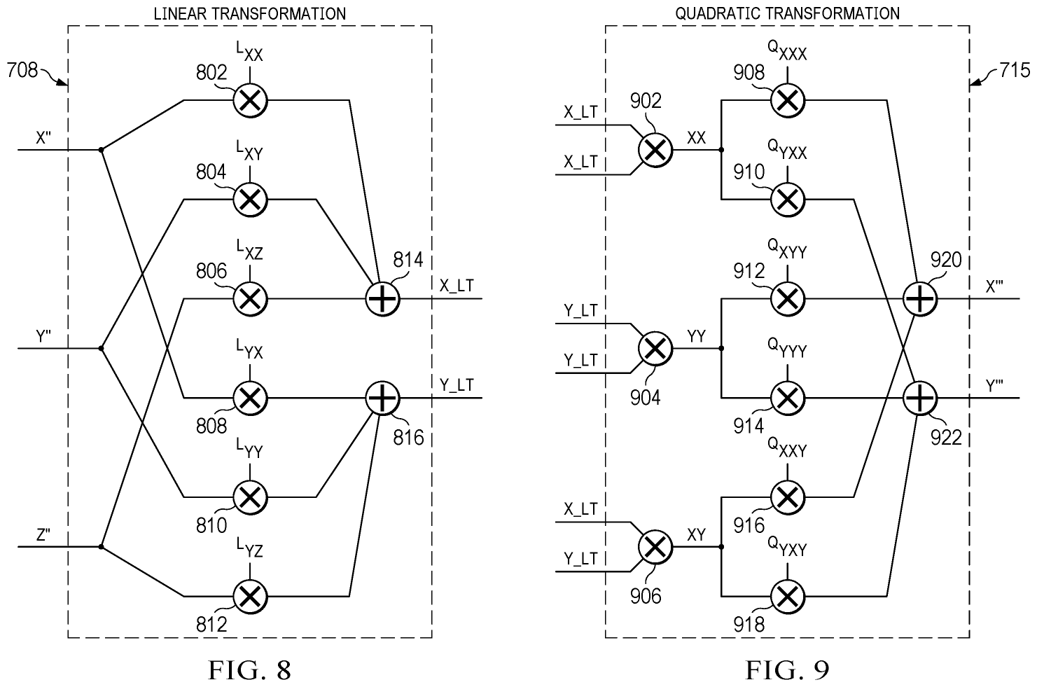

FIG. 8 is a block diagram of the linear transformation 708. In this example, linear transformation 708 includes multipliers 802, 804, 806, 808, 810, and 812 and adders 814 and 816. Multiplier 802 multiplies X″ by a value L_{XX}. The output value from multiplier 802 is provided to an input of adder 814. Multiplier 804 multiplies Y″ by a value L_{XY}. The output value from multiplier 804 is provided to another input of adder 814. Multiplier 806 multiplies Z″ by a value L_{XZ}. The output value from multiplier 806 is provided to yet another input of adder 814. Adder 814 adds the values from multipliers 802, 804, and 806 to produce output value X_LT. Multiplier 808 multiplies X″ by a value L_{YX}. The output value from multiplier 808 is provided to an input of adder 816. Multiplier 810 multiplies Y″ by a value L_{YY}. The output value from multiplier 810 is provided to another input of adder 816. Multiplier 812 multiplies Z″ by a value L_{YZ}. The output value from multiplier 812 is provided to yet another input of adder 816. Adder 816 adds the values from multipliers 808, 810, and 812 to produce output value Y_LT.

The calibration matrix described above includes the values L_{XX}, L_{XY}, L_{XZ}, L_{YX}, L_{YY}, and L_{YZ} arranged as a 3×2 matrix, which is multiplied, per linear transformation 708, with a 1×3 vector including the coordinate X″, Y″, Z″ per Eq. (2) below.

$$[ \begin{matrix}X\_LT \\ Y\_LT\end{matrix} ] = [ \begin{matrix}{X}^{″} \\ {Y}^{″} \\ {Z}^{″}\end{matrix} ] * [ \begin{matrix}{L}_{XX} & {L}_{XY} & {L}_{XZ} \\ {L}_{YX} & {L}_{YY} & {L}_{YZ}\end{matrix} ] \qquad ( Eq . 2 )$$

FIG. 9 is a block diagram of the quadratic transformation 715. In this example, the quadratic transformation includes multipliers 902, 904, 906, 908. 910. 912. 914, 916, and 918 and adders 920 and 922. Multiplier 902 multiplies X″ by X″, in other words, computes the square of X″, to produce output XX. Similarly, multiplier 904 multiplies Y″ by Y″ to compute the square of Y″ as output YY. Multiplier 906 multiplies X″ by Y″ to compute XY.

Multiplier 908 multiplies XX by a value Q_{XXX} and provides the product to an input of adder 920. Multiplier 912 multiplies YY by a value Q_{XYY} and provides the product to another input of adder 920. Multiplier 916 multiplies XY by a value Q_{XXY} and provides the product to another input of adder 920. Adder 920 adds the products from multipliers 908, 912, and 916 to produce output X″′.

Multiplier 910 multiplies XX by a value Q_{YXX} and provides the product to an input of adder 922. Multiplier 914 multiplies YY by a value Q_{YYY} and provides the product to another input of adder 922. Multiplier 918 multiplies XY by a value Q_{YXY} and provides the product to another input of adder 922. Adder 922 adds the products from multipliers 910, 914, and 918 to produce output Y′″.l In one example, the values of Q_{XXX}, Q_{YXX}, Q_{XYY}, Q_{YYY}, Q_{XXY}, and Q_{YXY} are determined by a least mean squares (LMS) technique to further reduce the Z component.

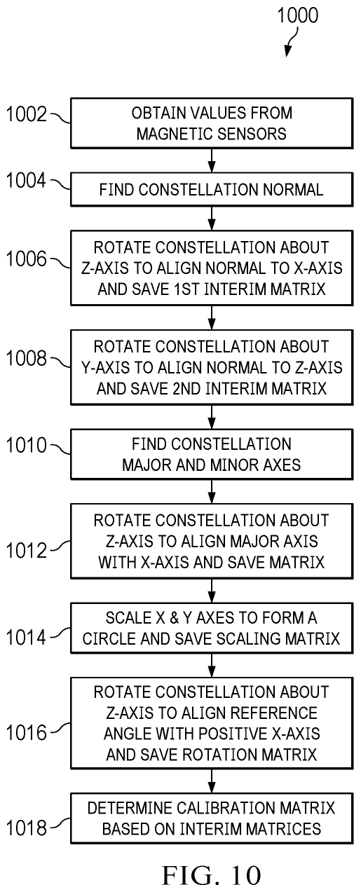

FIG. 10 is a flow diagram 1000 of an example process for determining the calibration matrix, which is the 3×2 matrix in Eq. (2) above. The calibration matrix is the combination, e.g., product, of multiple interim rotation matrices that implements the linear transformation 708. Each interim rotation matrix is a rotation matrix that rotates the constellation of coordinates about one of the X, Y, or Z axes. The rotation matrices for rotating an object about any of the X, Y, or Z axes are:

$${R}_{x} ( φ ) = [ \begin{matrix}1 & 0 & 0 \\ 0 & cos ( φ ) & - sin ( φ ) \\ 0 & cos ( φ ) & cos ( φ )\end{matrix} ] \qquad ( Eq . 3 )$$

$${R}_{y} ( φ ) = [ \begin{matrix}cos ( φ ) & 0 & sin ( φ ) \\ 0 & 1 & 0 \\ - sin ( φ ) & 0 & cos ( φ )\end{matrix} ] \qquad ( Eq . 4 )$$

$${R}_{z} ( φ ) = [ \begin{matrix}cos ( φ ) & - sin ( φ ) & 0 \\ sin ( φ ) & cos ( φ ) & 0 ) \\ 0 & 0 & 1\end{matrix} ] \qquad ( Eq . 5 )$$

where Rₓ(φ), R_{y}(φ), and R_{z}(φ) are the rotation matrices about the X, Y, and Z axes, respectively, and angle φ is the angle through which the object is rotated about the corresponding axis. For example,) Rₓ(30⁰) is a matrix used to rotate an object by 30 degrees about the X-axis. Rotation of an object through a particular angle φ about one of the axes includes substituting φ into the cos and sin operators in the corresponding rotation matrix and then multiplying the rotation matrix by any given coordinate on the object to be rotated and repeating the multiplication for any other desired coordinates on the object to be rotated.

FIG. 10 is now described in conjunction with FIGS. 13A-13G. The operations of FIG. 10 may be performed by digital circuit 420. FIGS. 13A-13C graphically illustrate the rotation of the constellation of coordinates. Operation 1002 includes obtaining values from the magnetic sensors 132, 134, and 136. The collection of values from all three magnetic sensors represents a coordinate, and multiple coordinates may be obtained in operation 1002. As the constellation may be an ellipse in three-dimensional space, the number of coordinates obtained in operation 1002 may include 10 coordinates. With 10 coordinates, digital circuit 420 can determine the equation for the ellipse in three-dimensional space using the equation:

$${Ax}^{2} + Bxy + Cxz + {Dy}^{2} + Eyz + {Fz}^{2} + Gx + Hy + Iz + J = 0 \qquad ( Eq . 6 )$$

where A, B, C, D, E, F, G, H, I, and J are coefficients. In one example, digital circuit 420 determines the coefficients A through J based on 10 coordinates obtained of the ellipse.

In operation 1004, digital circuit 420 determines the equation of the line normal to the plane of the ellipse formed by the 10 coordinates obtained in operation 1002. In another example, because a plane can be specified based on three points, in operation 1002, digital circuit 420 may obtain three coordinates and, then use those three coordinates to determine the equation for the plane in which the ellipse resides. The equation for the ellipse's plane can then be used by digital circuit 420 to determine the line normal to that plane.

FIG. 13A shows an example of an ellipse 1310 formed by a constellation of the coordinates obtained in operation 1002. The units on the X, Y, and Z axes are milli-Teslas (mT). Although only a few (e.g., 3 or 10) coordinates are obtained in operation 1002, the ellipse 1310 on which those coordinates reside is shown in FIG. 13A. Line 1315 is the line normal to the plane of ellipse 1310, and is referred to as normal line 1315. FIG. 13A also identifies points 1321 and 1322 on the constellation. Point 1321 corresponds to a “zero-degree” point, and point 1322 corresponds to a 90 degree point relative to point 1321. The zero-degree point 1321 may represent point on the X-axis (0 degrees) but may not exactly align to the pole (e.g. north pole) of magnet 120 during the installation of the self-calibrating angle sensor device 130 relative to magnet 120.

In operation 1006, digital circuit 420 rotates the constellation about the Z-axis to align the ellipse so that normal line 1315 is in the X, Z plane as shown in FIG. 13B Digital circuit 420 may perform this rotation by determining the angle φ between line 1315 and the X-axis, computing the sin and cos values in the Rₓ(φ) rotation matrix of Eq. (3) using the computed angle φ, and then multiplying rotation matrix Rₓ(φ) by each of the coordinates obtained in operation 1002. The rotation matrix Rₓ(φ) determined using the computed angle φ is referred to as an interim rotation matrix (e.g., a first interim rotation matrix). Digital circuit 420 also saves the first interim matrix, e.g. in memory 514.

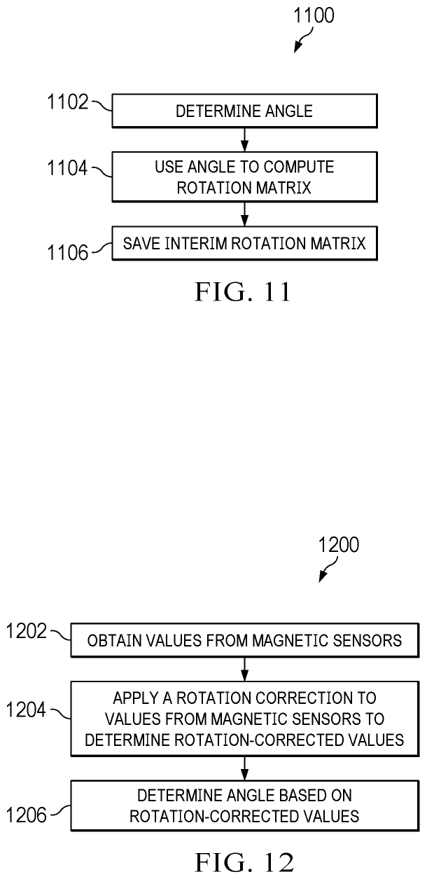

FIG. 11 shows an example flow diagram 1100 for how a three-dimensional rotation matrix can be determined. The logic flow of FIG. 11 can be performed by digital circuit 420. At operation 1102, digital circuit 420 determines angle φ, as described above. At operation 1104, digital circuit 420 then uses the angle φ to generate the cos and sin values in the corresponding rotation matrix, which digital circuit 420 then saves at operation 1106.

In operation 1008, digital circuit 420 rotates the constellation resulting from operation 1006 about the Y-axis to align the constellation normal to the Z-axis, as shown in FIG. 13C. Digital circuit 420 may perform this rotation by determining a rotation matrix as shown in FIG. 11 using rotation matrix R_{y}(φ) and determining the angle φ between the normal line 1315 of ellipse 1310 and the Y-axis.

Digital circuit 420 may then multiply the rotation matrix R_{y}(φ) by each of the coordinates resulting from operation 1006. The rotation matrix R_{y}(φ) determined using the newly computed angle φ is referred to as an interim rotation matrix (e.g., a second interim rotation matrix). Digital circuit 420 also saves the second interim matrix, e.g., in memory 514.

After the rotations of operations 1006 and 1008, as shown in FIG. 13C the ellipse 1310 is predominantly in just the X, Y plane and most or all of the Z component of the original ellipse 1310 in FIG. 13A has been removed. Any remaining Z component in ellipse 1310 can be further reduced, if desired, by the digital circuit 420 performing the quadratic transformation 715.

FIG. 13D is a graph in just the X and Y axes of the ellipse 1310 from FIG. 13C. At operation 1010, digital circuit 420 determines the major and minor axes of ellipse 1310. An ellipse's major axis is along its longest radius, and its minor axis is along its shortest radius. At operation 1012, digital circuit 420 rotates the constellation of ellipse 1310 to align its major axis with the X- axis, as shown in FIG. 13E. Digital circuit 420 may perform this two-dimensional rotation by rotating the ellipse 1310 about the Z-axis. A Z-axis rotation may be performed by multiplying the R_{z}(φ) rotation matrix of Eq. (5) above by the points on ellipse 1310 while setting the value of Z in the result to a value of 0. The value of φ is the angle through which ellipse 1310 is to be rotated about the Z-axis. Digital circuit 420 saves this two-dimensional interim rotation matrix.

In operation 1014, digital circuit 420 scales ellipse 1310 resulting from operation 1012 to convert it to a circle, as shown in FIG. 13F. Digital circuit 420 may perform this operation by multiplying each coordinate by an interim scaling matrix which includes multiplying the Y-component of all (X,Y) points by A, where A=major axis/minor axis. Digital circuit 420 saves the interim scaling matrix, e.g., in memory 514.

In operation 1016, digital circuit 420 rotates ellipse 1310 resulting from operation 1014 to align the zero-degree point 1321 with the X-axis, as shown in FIG. 13G. Digital circuit 420 uses another instance of a two-dimensional interim rotation matrix to perform this rotation and saves the interim rotation matrix, e.g., in memory 514.

At operation 1018, digital circuit 420 determines the calibration matrix (3×2 matrix in Eq. (2)) based on the interim matrices determined in operations 1006, 1008, 1012, 1014, and 1016. In one example, digital circuit determines the calibration matrices by multiplying the interim matrices together in the order they were generated in FIG. 10.

The constellation resulting from the linear transformation of the operations illustrated in FIG. 10 may still have a Z component, albeit likely fairly small. The shape of the constellation with the Z component may have a “saddle” shape. If desired, to further reduce any remaining Z-component in the constellation, quadratic transformation 715 can be applied. An LMS technique can be used to determine the coefficients Q_{XXX}, Q_{YXX}, Q_{XYY}, Q_{YYY}, Q_{XXY}, and Q_{YXY}, described above, that sufficiently maps the saddle-shaped constellation to a planar circle thereby reducing any Z-component remaining from the linear transformation.

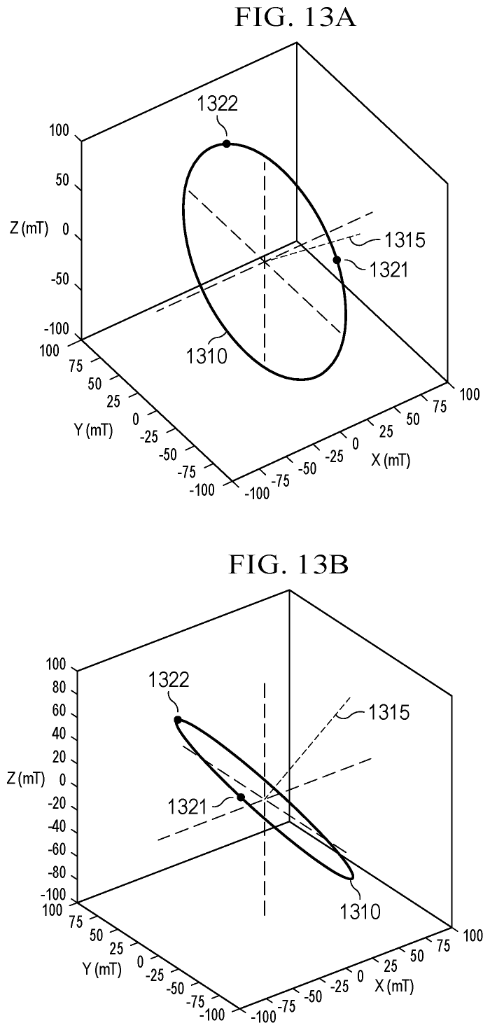

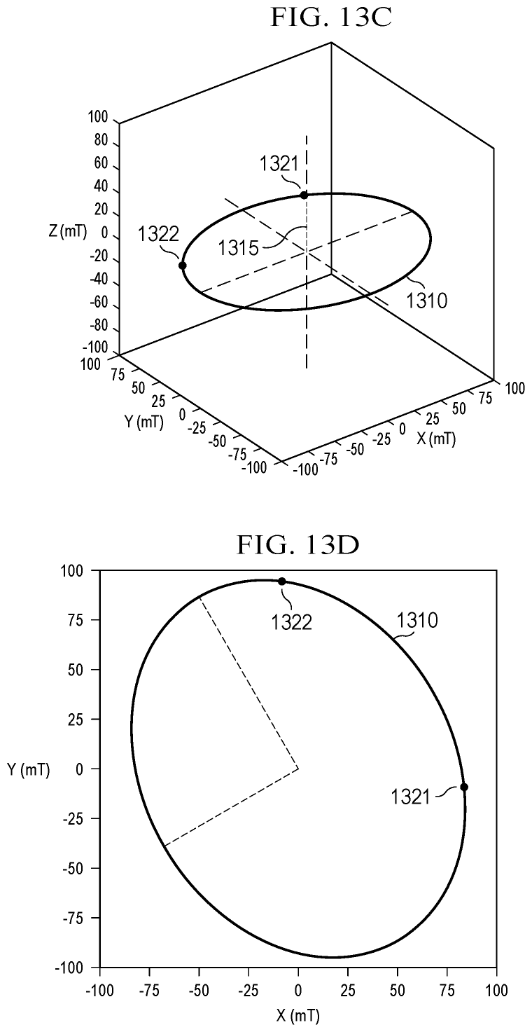

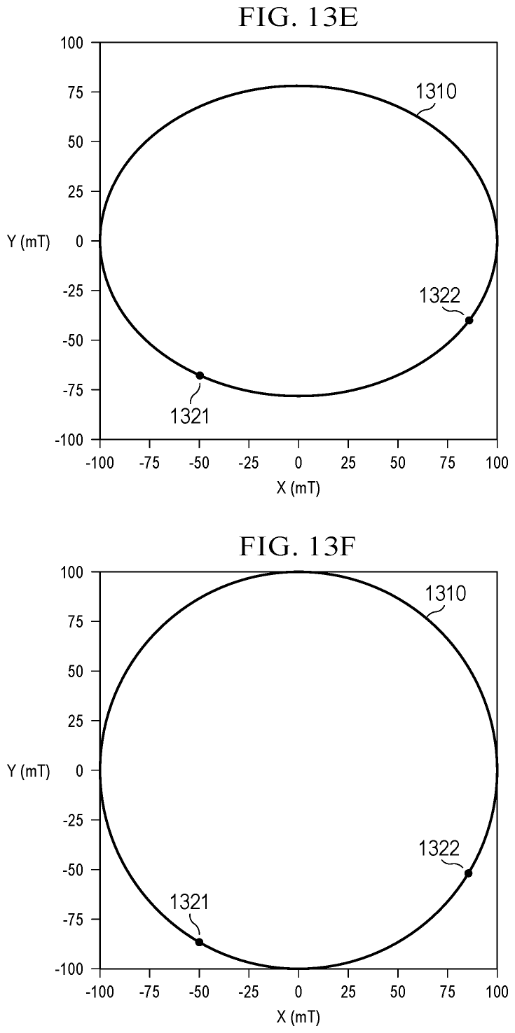

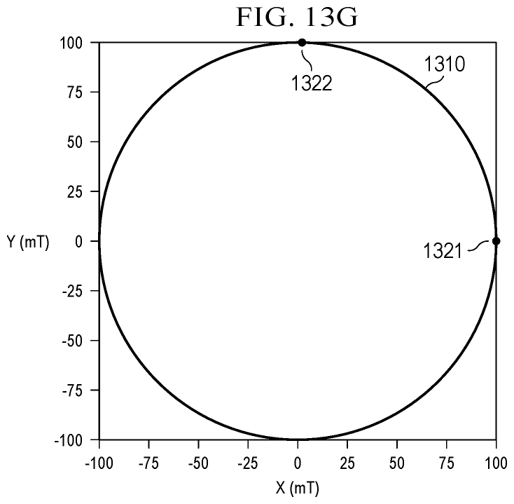

FIG. 12 is a flow diagram 1200 illustrating an example of how to use the calibration matrix generated according to the example of FIG. 11. At operation 1202, digital circuit 420 obtains values from the magnetic sensors 132, 134, and 136. At operation 1204, digital circuit 420 applies a rotation correction to the values from the magnetic sensors to determine rotation-corrected values. Digital circuit 420 may perform the rotation correction by applying the calibration matrix to the sensors. In a specific example, digital circuit 420 applies the rotation correction by multiplying the values by the calibration matrix. At operation 1206, CORDIC 624, which may be implemented by digital circuit 420, determines the shaft angle Θ based on the rotation-corrected values, e.g., using Eq. (1). The offset correction 612 and temperature calibration 616 also may be performed by digital circuit 420, e.g., between operations 1202 and 1204.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. An integrated circuit (IC), comprising:
a first magnetic sensor;
a second magnetic sensor;
a third magnetic sensor;
an analog-to-digital converter (ADC) having an input coupled to the first, second, and third magnetic sensors, and having an output; and
a digital circuit having an input coupled to the output of the ADC, the digital circuit configured to:
obtain first digital sensor values from the ADC;
determine interim rotation matrices for rotation of the first digital sensor values; and
determine a calibration matrix based on the interim rotation matrices.

2. The IC of claim 1, wherein the digital circuit is configured to determine the calibration matrix by multiplying together the interim rotation matrices.

3. The IC of claim 1, wherein the digital circuit is configured to determine the interim rotation matrices by:
determining a direction normal to a constellation of the digital sensor values;
determining a first interim rotation matrix to rotate the constellation about a first axis to produce a first rotated constellation; and
determining a second interim rotation matrix to rotate the first rotated constellation about a second axis to produce a second rotated constellation.

4. The IC of claim 3, wherein the digital circuit is configured to determine the calibration matrix by multiplying the first interim rotation matrix by the second interim rotation matrix.

5. The IC of claim 3, wherein the digital circuit is configured to:
determine a third interim rotation matrix to rotate the second rotated constellation about one of the first and second axes to produce a third rotated constellation;
determine a scaling matrix to scale the third rotated constellation; and
determine the calibration matrix based on the first interim rotation matrix, the second interim rotation matrix, the third interim rotation matrix, and the scaling matrix.

6. The IC of claim 5, wherein the digital circuit is configured to determine the calibration matrix by multiplying together the first interim rotation matrix, the second interim rotation matrix, the third interim rotation matrix, and the scaling matrix.

7. The IC of claim 1, wherein the digital circuit is configured to correct second digital sensor values using the calibration matrix.

8. The IC of claim 7, wherein the digital circuit is configured to correct the second digital sensors values by multiplying the second digital sensor values by the calibration matrix.

9. The IC of claim 7, wherein the digital circuit is configured to perform a least mean square (LMS) operation on a result of multiplying the second digital sensor values by the calibration matrix to map a planar circle to the result.

10. An integrated circuit (IC), comprising:
magnetic sensors;
an analog-to-digital converter (ADC) having an input coupled to the magnetic sensors, and having an output; and
a digital circuit having an input coupled to the output of the ADC, the digital circuit configured to:
apply a rotation correction to digital sensor values from the ADC to determine rotation-corrected sensor values; and
determine an angle based on the rotation-corrected sensor values.

11. The IC of claim 10, wherein the digital circuit is configured to apply the rotation correction to the digital sensor values by applying a matrix to the digital sensor values.

12. The IC of claim 10, wherein the digital circuit is configured to apply the rotation correction to the digital sensor values by multiplying the digital sensor values by a correction matrix.

13. The IC of claim 10, wherein the digital circuit is configured to determine the rotation correction by:
obtaining first digital sensor values from the ADC;
determining interim rotation matrices for rotation of the first digital sensor values; and
determining a calibration matrix based on the interim rotation matrices.

14. The IC of claim 13, wherein the digital circuit is configured to determine the calibration matrix by multiplying the interim rotation matrices together to compute the calibration matrix.

15. A method, comprising:
obtaining values from magnetic sensors;
determining interim rotation matrices for rotation of the sensor values; and
determining a calibration matrix based on the interim rotation matrices.

16. The method of claim 15, wherein obtaining values from the magnetic sensors includes obtaining values from first, second, and third orthogonally-arranged magnetic sensors.

17. The method of claim 15, wherein determining the calibration matrix includes multiplying together the interim rotation matrices.

18. A method, comprising:
applying a rotation correction to values from magnetic sensors to determine rotation-corrected sensor values; and
determining an angle based on the rotation-corrected sensor values.

19. The method of claim 18, wherein applying the rotation correction to the values includes applying a matrix to the values.

20. The method of claim 18, wherein applying the rotation correction to the values includes multiplying the values by a calibration matrix.

21. A method, comprising:
obtaining first values from magnetic sensors;
determining interim rotation matrices for rotation of the first values;
determining a calibration matrix based on the interim rotation matrices;
applying the calibration matrix to second values from the magnetic sensors to determine rotation-corrected sensor values; and
determining an angle based on the rotation-corrected sensor values.

22. The method of claim 21, wherein the first values include values from a first, second, and third magnetic sensor, and the second values includes values from two magnetic sensors of the first, second, and third magnetic sensors.
